(19) United States
(12) Patent Application Publication
(10) Pub. No.: US 2014/0347484 A1
(43) Pub. Date: Nov. 27, 2014

(54) APPARATUS AND METHOD FOR PROVIDING SURROUNDING ENVIRONMENT INFORMATION OF VEHICLE

(71) Applicant: Electronics and Telecommunications Research Institute, Daejeon (KR)

(72) Inventors: Jae-Min BYUN, Gyeryong (KR); Ki-In NA, Daejeon (KR); Myung-Chan ROH, Daejeon (KR); Joo-Chan SOHN, Daejeon (KR); Sung-Hoon KIM, Daejeon (KR)

(73) Assignee: Electronics and Telecommunications Research Institute, Daejeon (KR)

(21) Appl. No.: 14/254,826

(22) Filed: Apr. 16, 2014

(30) Foreign Application Priority Data
May 23, 2013 (KR) 10-2013-0058234

(51) Int. Cl. G06K 9/00

(52) U.S. Cl. CPC G06K 9/00798
USPC 348/148

(57) ABSTRACT

The present invention relates to an apparatus and method for providing the surrounding environment information of a vehicle. The apparatus includes a first information extraction unit for collecting sensing information about a surrounding environment of a vehicle and extracting lane information and object information based on the sensing information. A second information extraction unit acquires an image of the surrounding environment of the vehicle, and extracts lane information and object information based on the image. An information integration unit matches and compares the lane information and the object information extracted by the first information extraction unit with the lane information and the object information extracted by the second information extraction unit, determining ultimate lane information and ultimate object information based on results of comparison, and providing the ultimate lane information and the ultimate object information to a control unit of the vehicle.

### CROSS REFERENCE TO RELATED APPLICATION

This application claims the benefit of Korean Patent Application No. 10-2013-0058234 filed on May 23, 2013, which is hereby incorporated by reference in its entirety into this application.

### BACKGROUND OF THE INVENTION

1. Technical Field

The present invention relates generally to an apparatus and method for providing the surrounding environment information of a vehicle and, more particularly, to an apparatus and method for providing the surrounding environment information of a vehicle, which integrate image information about the surrounding environment of the vehicle collected from a camera with sensing information about the surrounding environment of the vehicle collected from a three-dimensional (3D) Light Detection and Ranging (LIDAR) device, and provide integrated information.

2. Description of the Related Art

Recently, there has been developed technology for recognizing an image of an obstacle present in a traffic lane on a road using a camera or the like when a vehicle, such as a privately-driven car or a bus, moves along the traffic lane, thus preparing for safe driving.

For example, as one example of technology for recognizing an obstacle using an image, a stereo vision scheme is present. Such a stereo-vision scheme is a scheme for searching left and right images, which are acquired by two cameras horizontally installed on left and right sides of a vehicle towards the forward direction of the vehicle, for corresponding points of an obstacle (correspondence problem), and calculating 3D coordinate values using a difference between the spatial viewpoints for the corresponding points.

However, such a stereo-vision scheme is problematic in that it is difficult to search an image acquired by one camera for matching points corresponding to respective pixels in an image acquired by the other camera, thus making it difficult to actually utilize the stereo-vision scheme. Further, there is a problem in that the recognition performance of cameras is greatly influenced by variations in the surrounding lighting of the vehicle.

Meanwhile, as another example for technology for recognizing an obstacle using an image, there is a scheme for assuming that a portion estimated to be an obstacle in a single image is not an object protruding from a road surface, such as a shadow or a piece of newspaper, and calculating a location in a road coordinate system from an image coordinate system using a coordinate conversion method, as disclosed in Korean Patent Application Publication No. 10-2006-0021922.

That is, this patent presents a method of, when points in the road coordinate system are viewed from a camera installed at another location in a horizontal direction, calculating locations on a screen at which those points will appear by using a coordinate conversion method, determining whether the locations at which the points will appear on the screen are identical to the locations of actually captured points, and rejecting the assumption that the portion estimated to be the obstacle is not an object protruding from the road surface if the locations are not identical to each other, thus recognizing the obstacle protruding from the road surface.

However, the scheme for calculating locations in the road coordinate system from the image coordinate system may be more simply applied than a stereo-vision method, but is problematic in that the entire contour of an image part suspected to be an obstacle must be extracted, and a difference occurs between images viewed from left and right cameras.

### SUMMARY OF THE INVENTION

Accordingly, the present invention has been made keeping in mind the above problems occurring in the prior art, and an object of the present invention is to provide an apparatus and method for providing the surrounding environment information of a vehicle, which integrate the lane and object information of a vehicle extracted from image information about the surrounding environment collected from a camera with the lane and object information of the vehicle extracted from sensing information about the surrounding environment collected from a 3D Light Detection and Ranging (LIDAR) device, and provide integrated information, thus exactly detecting the surrounding environment information of the vehicle.

Another object of the present invention is to provide an apparatus and method for providing the surrounding environment information of a vehicle, which can prevent the vehicle from departing from a lane based on provided lane information.

A further object of the present invention is to provide an apparatus and method for providing the surrounding environment information of a vehicle, which can prevent the vehicle from colliding with an obstacle based on provided object information.

In accordance with an aspect of the present invention to accomplish the above objects, there is provided an apparatus for providing surrounding environment information of a vehicle, including a first information extraction unit for collecting sensing information about a surrounding environment of a vehicle and extracting lane information and object information based on the sensing information; a second information extraction unit for acquiring an image of the surrounding environment of the vehicle, and extracting lane information and object information based on the image; and an information integration unit for matching and comparing the lane information and the object information extracted by the first information extraction unit with the lane information and the object information extracted by the second information extraction unit, determining ultimate lane information and ultimate object information based on results of comparison, and providing the ultimate lane information and the ultimate object information to a control unit of the vehicle.

Preferably, the sensing information may be obtained by emitting laser light and receiving reflected laser light, and is sensed by a three-dimensional (3D) Light Detection and Ranging (LIDAR) device in a form of information about a distance to an object, a direction of the object, and an angle with a road surface.

Preferably, the first information extraction unit may include a location information collection unit for collecting location information based on information about a distance between the vehicle and the object; a reflectance information collection unit for collecting reflectance information based on information about an angle between the vehicle and a road surface; a first conversion unit for combining the location information with the direction information, and converting combined information into 3D spatial coordinate information; a first lane information extraction unit for extracting the lane information based on the reflectance information; a first object information extraction unit for extracting the object information including any one of shape information and size information of the object based on the 3D spatial coordinate information; and a first transmission unit for transmitting the extracted lane information and object information to the information integration unit.

Preferably, the second information extraction unit may include an image information acquisition unit for acquiring an image of the surrounding environment of the vehicle via an image acquisition unit; a second lane information extraction unit for extracting the lane information including any one of shape, color, and location of a lane from the image; and a second object information extraction unit for extracting the object information including any one of type, size, location, and velocity of the object from the image.

Preferably, the second information extraction unit may include a second conversion unit for converting the extracted lane information and object information into a form of 3D spatial coordinate information; and a second transmission unit for transmitting the converted lane information and object information to the information integration unit.

Preferably, the information integration unit may include an information matching unit for performing time synchronization between the lane information and the object information extracted by the first information extraction unit and the lane information and the object information extracted by the second information extraction unit, and matching time-synchronized lane information and object information with predefined spatial coordinates; a lane information comparison unit for comparing pieces of matched lane information with each other; a lane information determination unit for measuring reliability values of the pieces of lane information based on results of comparison, and determining lane information having a highest reliability value to be ultimate lane information; an object information comparison unit for comparing pieces of matched object information with each other; an object information determination unit for measuring reliability values of the pieces of object information based on results of the comparison, and determining corresponding object information to be ultimate object information if a measured reliability value of the corresponding object information is equal to or greater than a preset reference reliability value; and an information provision unit for providing the ultimate lane information and the ultimate object information to a control unit of the vehicle.

In accordance with another aspect of the present invention to accomplish the above objects, there is provided a method for providing surrounding environment information of a vehicle, including collecting, by a first information extraction unit, sensing information about a surrounding environment of a vehicle and extracting lane information and object information based on the sensing information, and acquiring, by a second information extraction unit, an image of the surrounding environment of the vehicle and extracting lane information and object information based on the image; matching and comparing, by an information integration unit, the lane information and the object information extracted by the first information extraction unit with the lane information and the object information extracted by the second information extraction unit; determining, by the information integration unit, ultimate lane information and ultimate object information based on results of comparison; and providing, by the information integration unit, the ultimate lane information and the ultimate object information to a control unit of the vehicle.

Preferably, the sensing information may be obtained by emitting laser light and receiving reflected laser light, and is sensed by a three-dimensional (3D) Light Detection and Ranging (LIDAR) device in a form of information about a distance to an object, a direction of the object, and an angle with a road surface.

Preferably, collecting the sensing information and extracting the lane information and the object information may include collecting location information based on information about a distance between the vehicle and the object, and collecting reflectance information based on information about an angle between the vehicle and a road surface; combining the location information with the direction information, and converting combined information into 3D spatial coordinate information; extracting the lane information based on the reflectance information, and extracting the object information including any one of shape information and size information of the object based on the 3D spatial coordinate information; and transmitting the extracted lane information and object information to the information integration unit.

Preferably, acquiring the image and extracting the lane information and the object information may include acquiring an image of the surrounding environment of the vehicle via an image acquisition unit; extracting the lane information including any one of shape, color, and location of a lane from the image, and extracting the object information including any one of type, size, location, and velocity of the object from the image; converting the extracted lane information and object information into a form of 3D spatial coordinate information; and transmitting the converted lane information and object information to the information integration unit.

Preferably, matching and comparing the lane information and the object information may be configured to perform time synchronization between the lane information and the object information extracted by the first information extraction unit and the lane information and the object information extracted by the second information extraction unit, and to match and compare time-synchronized lane information and object information with predefined spatial coordinates.

Preferably, determining the ultimate lane information and the ultimate object information may be configured to measure reliability values of pieces of lane information based on results of comparison, determine lane information having a highest reliability value to be ultimate lane information, measure reliability values of pieces of object information based on results of comparison, and determine corresponding object information to be ultimate object information if a measured reliability value of the corresponding object information is equal to or greater than a preset reference reliability value.

The apparatus and method for providing the surrounding environment information of the vehicle according to the present invention having the above configuration are advantageous in that the lane and object information of the vehicle extracted from the image information of the surrounding environment collected by a camera are integrated with the lane and object information of the vehicle extracted from the sensing information of the surrounding environment collected by a 3D LIDAR device, and integrated information is provided, so that the surrounding environment information of the vehicle may be exactly detected, and thus the safe driving of a driver may be promoted.

Further, the present invention is advantageous in that it may prevent the vehicle from departing from a lane and from colliding with an obstacle, based on provided lane information and object information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for providing the surrounding environment information of a vehicle according to an embodiment of the present invention;

FIG. 2 is a diagram showing the detailed configuration of a first information extraction unit employed in the apparatus for providing the surrounding environment information of a vehicle according to an embodiment of the present invention;

FIG. 3 is a diagram showing the detailed configuration of a second information extraction unit employed in the apparatus for providing the surrounding environment information of a vehicle according to an embodiment of the present invention;

FIG. 4 is a diagram showing the detailed configuration of an information integration unit employed in the apparatus for providing the surrounding environment information of a vehicle according to an embodiment of the present invention;

FIG. 5 is a flowchart showing the sequence of a method for providing the surrounding environment information of a vehicle according to an embodiment of the present invention; and

FIGS. 6 and 7 are flowcharts showing an information extraction sequence in the method for providing the surrounding environment information of a vehicle according to an embodiment of the present invention.

FIG. 8 is an embodiment of the present invention implemented in a computer system.

### DESCRIPTION OF THE PREFERRED EMBODIMENTS

Embodiments of the present invention will be described with reference to the accompanying drawings in order to describe the present invention in detail so that those having ordinary knowledge in the technical field to which the present pertains can easily practice the present invention. It should be noted that same reference numerals are used to designate the same or similar elements throughout the drawings. In the following description of the present invention, detailed descriptions of known functions and constructions which are deemed to make the gist of the present invention obscure will be omitted.

Hereinafter, an apparatus and method for providing the surrounding environment information of a vehicle according to embodiments of the present invention will be described in detail with reference to the attached drawings.

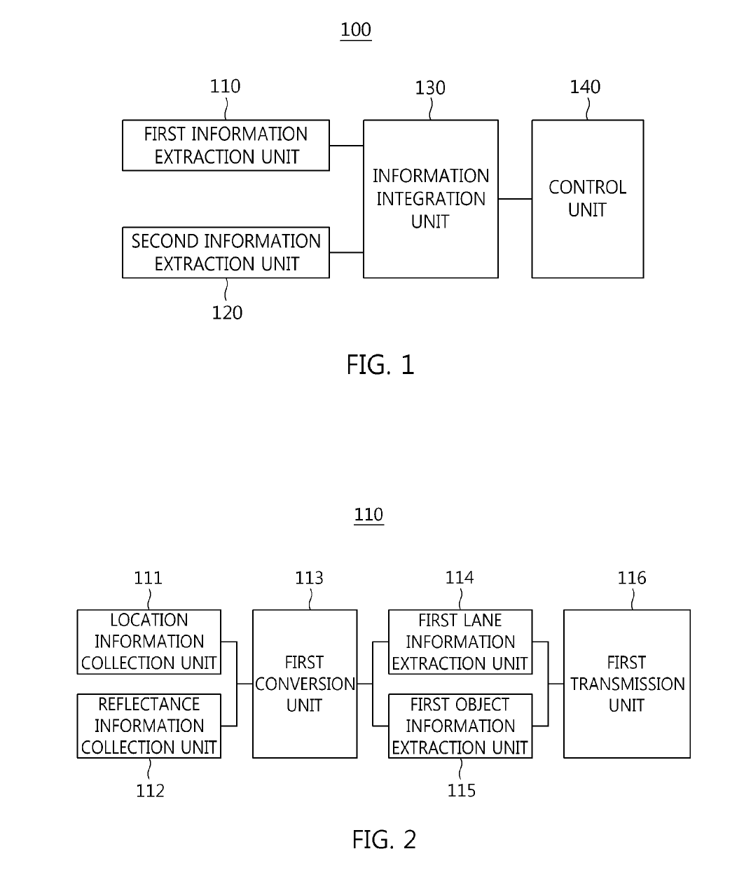

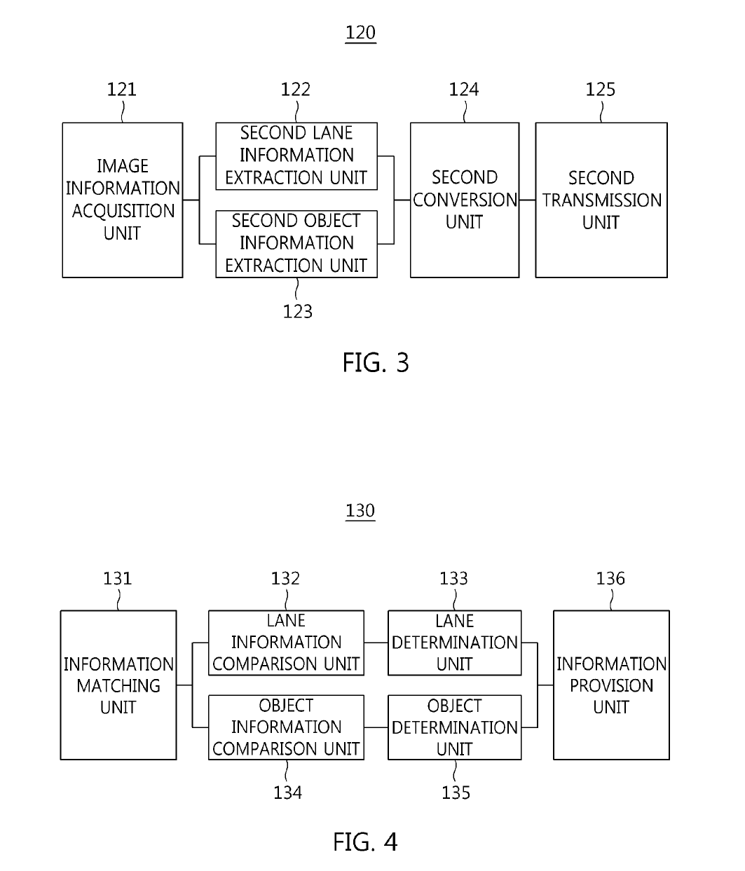

FIG. 1 is a diagram showing the configuration of an apparatus for providing the surrounding environment information of a vehicle according to an embodiment of the present invention, FIG. 2 is a diagram showing the detailed configuration of a first information extraction unit employed in the apparatus for providing the surrounding environment information of a vehicle according to an embodiment of the present invention, FIG. 3 is a diagram showing the detailed configuration of a second information extraction unit employed in the apparatus for providing the surrounding environment information of a vehicle according to an embodiment of the present invention, and FIG. 4 is a diagram showing the detailed configuration of an information integration unit employed in the apparatus for providing the surrounding environment information of a vehicle according to an embodiment of the present invention.

Referring to FIG. 1, an apparatus 100 for providing the surrounding environment information of a vehicle according to the present invention chiefly includes a first information extraction unit 110, a second information extraction unit 120, and an information integration unit 130.

The first information extraction unit 110 collects sensing information about the surrounding environment of the vehicle, and extracts lane information and object information based on the sensing information. In this case, the sensing information denotes information obtained by emitting laser light and receiving reflected laser light, and sensed by a 3D LIDAR device in the form of information about a distance to the object, the direction of the object, and an angle with a road surface. In greater detail, the 3D LIDAR device collects pieces of information about an object for each angle unit within the range of angles limited in vertical and horizontal directions with respect to the emission direction of light.

For this operation, as shown in FIG. 2, the first information extraction unit 110 includes a location information collection unit 111, a reflectance information collection unit 112, a first conversion unit 113, a first lane information extraction unit 114, a first object information extraction unit 115, and a first transmission unit 116.

The location information collection unit 111 collects pieces of location information based on information about a distance between the vehicle and the object. The object described in the present invention may be one of a pedestrian, an obstacle, a vehicle, and a building.

The reflectance information collection unit 112 collects pieces of reflectance information based on information about an angle between the vehicle and the road surface.

The first conversion unit 113 combines direction information with the location information, and converts the combined information into 3D spatial coordinate information. That is, the first conversion unit 113 combines the location information and the direction information, performs a division and classification procedure based on 3D point clouds, and then converts the direction and location information into 3D spatial coordinate information.

The first lane information extraction unit 114 extracts lane information based on the reflectance information.

The first object information extraction unit 115 extracts object information including any one of the shape information and the size information of the object based on the 3D spatial coordinate information.

The first transmission unit 116 transmits the extracted lane information and the extracted object information to the information integration unit.

The second information extraction unit 120 acquires an image of the surrounding environment of the vehicle, and extracts lane information and object information based on the image.

For this operation, as shown in FIG. 3, the second information extraction unit 120 includes an image information acquisition unit 121, a second lane information extraction unit 122, a second object information extraction unit 123, a second conversion unit 124, and a second transmission unit 125.

The image information acquisition unit 121 acquires an image of the surrounding environment of the vehicle. In this case, the image information acquisition unit 121 acquires a color image of the surrounding environment of the vehicle in the same direction as that of the above-described 3D LIDAR device using an image collection module such as a camera.

The second lane information extraction unit 122 extracts lane information including any one of the shape, color, and location of a lane from the image.

The second object information extraction unit 123 extracts object information including any one of the type, size, location, and velocity of the object from the image.

The second conversion unit 124 converts the extracted lane information and the extracted object information into the form of 3D spatial coordinate information. In this case, the second conversion unit 124 converts the extracted information from the form of camera coordinates of the image information acquisition unit 121 into the form of 3D spatial coordinates, which is identical to that of the first conversion unit.

The second transmission unit 125 transmits the converted lane information and object information to the information integration unit 130.

The information integration unit 130 matches and compares the lane information and object information extracted by the first information extraction unit 110 with the lane information and object information extracted by the second information extraction unit 120, determines ultimate lane information and ultimate object information based on the results of the comparison, and provides the ultimate lane information and ultimate object information to the control unit of the vehicle.

For this operation, as shown in FIG. 4, the information integration unit 130 includes an information matching unit 131, a lane information comparison unit 132, a lane determination unit 133, an object information comparison unit 134, an object determination unit 135, and an information provision unit 136.

The information matching unit 131 matches the lane information and object information extracted by the first information extraction unit 110 with the lane information and object information extracted by the second information extraction unit 120. The information matching unit 131 performs time synchronization between the lane information and object information extracted by the first information extraction unit 110 and the lane information and object information extracted by the second information extraction unit 120 due to a time difference between them, and thereafter matches the corresponding information with predefined spatial coordinates.

The lane information comparison unit 132 compares the pieces of matched lane information with each other.

The lane information determination unit 133 measures the reliability values of the pieces of lane information based on the results of the comparison and then determines ultimate lane information. In this case, the term “reliability” means the conformity degree of pieces of information that are matched and compared with each other. Therefore, the ultimate lane information determined by the lane information determination unit 133 is lane information having a highest reliability value among the results of matching and comparing the lane information extracted by the first information extraction unit 110 and the lane information extracted by the second information extraction unit 120.

The object information comparison unit 134 compares the pieces of matched object information with each other.

The object information determination unit 135 measures the reliability values of the pieces of object information based on the results of the comparison, and then determines ultimate object information.

In this case, the ultimate object information determined by the object information determination unit 135 denotes object information for which a reliability value, measured as a result of matching and comparing the object information extracted by the first information extraction unit 110 with the object information extracted by the second information extraction unit 120, is equal to or greater than a preset reference reliability value. That is, for object information for which the reliability value, measured as the result of matching and comparison, is equal to or greater than the preset reference reliability value, it is finally determined that any one of a pedestrian, an obstacle, a vehicle, and a building is present.

The information provision unit 136 provides the ultimate lane information and the ultimate object information to the control unit 140 of the vehicle, thus promoting the safe driving of a driver.

Here, the control unit 140 of the vehicle is an electronic control unit for controlling the status of the engine, the automatic transmission, the Anti-lock Braking System (ABS), etc. of the vehicle using a computer.

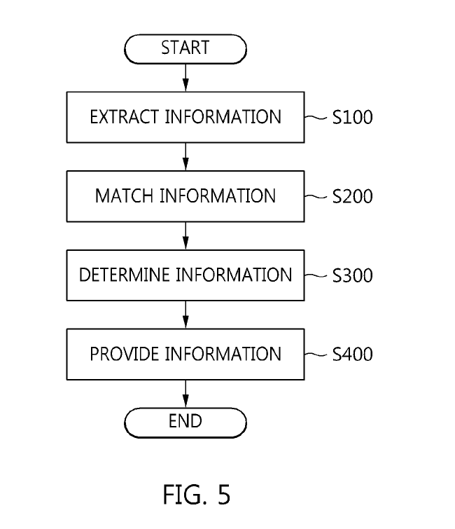

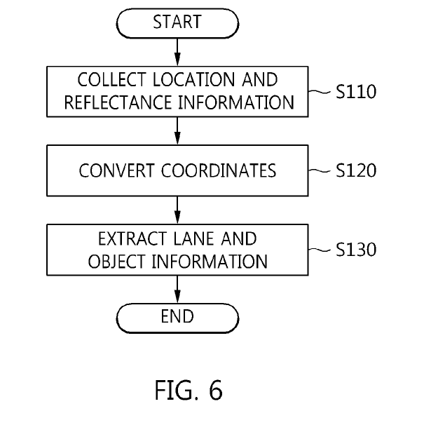

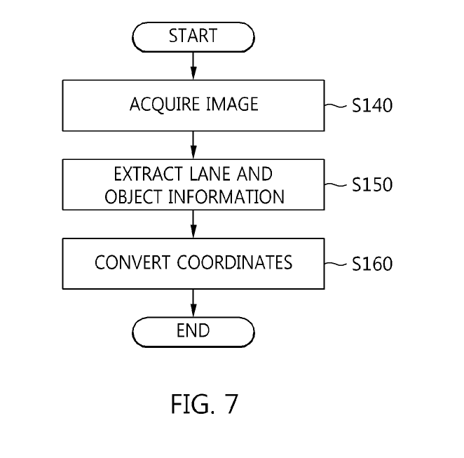

FIG. 5 is a flowchart showing the sequence of a method for providing the surrounding environment information of a vehicle according to an embodiment of the present invention, FIG. 6 is a flowchart showing the sequence of a procedure for collecting sensing information and extracting lane information and object information based on the sensing information in the method for providing the surrounding environment information of the vehicle according to an embodiment of the present invention, and FIG. 7 is a flowchart showing the sequence of a procedure for acquiring image information and extracting lane information and object information based on the image information in the method for providing the surrounding environment information of the vehicle according to an embodiment of the present invention.

Referring to FIG. 5, the method for providing the surrounding environment information of the vehicle is a method performed using the above-described apparatus 100 for providing the surrounding environment information of the vehicle, and thus repeated descriptions thereof will be omitted here.

First, by the first information extraction unit 110, sensing information about the surrounding environment of the vehicle is collected, and lane information and object information are extracted based on the sensing information, and, by the second information extraction unit 120, an image of the surrounding environment of the vehicle is acquired and lane information and object information are extracted based on the image at step S100. The sensing information of the first information extraction unit 110 denotes information obtained by emitting laser light and receiving reflected laser light and sensed by a 3D LIDAR device in the form of information about a distance to an object, the direction of the object, and an angle with a road surface. Therefore, as shown in FIG. 6, the first information extraction unit 110 collects location information between the vehicle and the object based on the sensing information sensed by the 3D LIDAR device and collects reflectance information based on information about the angle between the vehicle and the road surface at step S110. The location information and the reflectance information are converted into 3D spatial coordinate information at step S120, and then lane information and object information are extracted at step S130. Meanwhile, as shown in FIG. 7, the second information extraction unit 120 extracts lane information and object information at step S150 from the image of the surrounding environment of the vehicle acquired by the image information acquisition unit 121 at step S140, and converts the lane information and the object information into the form of 3D spatial coordinate information at step S160.

Next, by the information integration unit 130, the lane information and the object information extracted by the first information extraction unit 110 and the lane information and the object information extracted by the second information extraction unit 120 are matched and compared with each other at step S200. That is, time synchronization between the lane information and the object information extracted by the first information extraction unit 110 and the lane information and the object information extracted by the second information extraction unit 120 is performed, and time-synchronized lane information and object information are matched and compared with predefined spatial coordinates.

Then, by the information integration unit 130, ultimate lane information and ultimate object information are determined based on the results of the comparison at step S300. That is, the reliability values of the pieces of lane information are measured based on the results of the comparison, and lane information having a highest reliability value is determined to be ultimate lane information. Further, the reliability values of the pieces of object information are measured based on the results of the comparison. If the measured reliability value of the object information is equal to or greater than the preset reference reliability value, the corresponding object information is determined to be ultimate object information.

Finally, by the information integration unit 130, the ultimate lane information and the ultimate object information are provided to the control unit 140 of the vehicle at step S400.

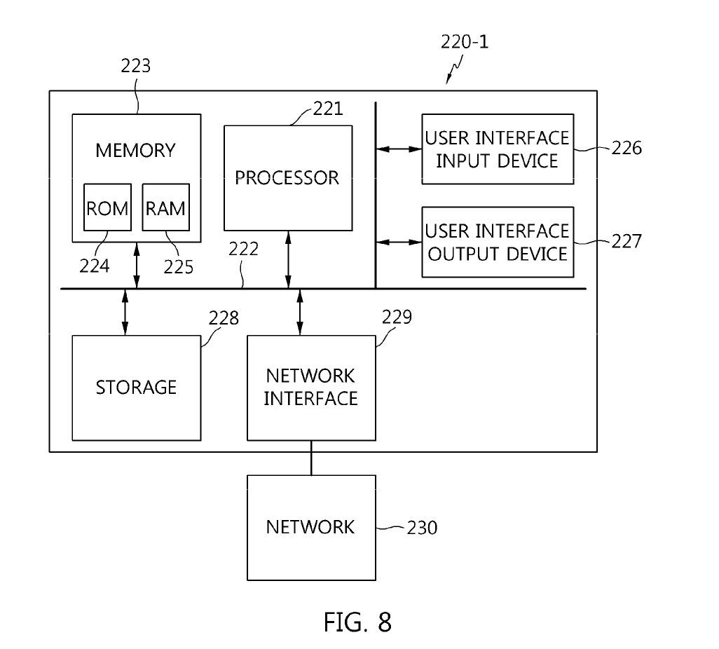

FIG. 8 is an embodiment of the present invention implemented in a computer system.

Referring to FIG. 8, an embodiment of the present invention may be implemented in a computer system, e.g., as a computer readable medium. As shown in in FIG. 8, a computer system 220-1 may include one or more of a processor 221, a memory 223, a user input device 226, a user output device 227, and a storage 228, each of which communicates through a bus 222. The computer system 220-1 may also include a network interface 229 that is coupled to a network 230. The processor 221 may be a central processing unit (CPU) or a semiconductor device that executes processing instructions stored in the memory 223 and/or the storage 228. The memory 223 and the storage 228 may include various forms of volatile or non-volatile storage media. For example, the memory may include a read-only memory (ROM) 224 and a random access memory(RAM) 225.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In this way, the apparatus and method for providing the surrounding environment information of the vehicle according to the present invention are configured to integrate the lane and object information of the vehicle extracted from the image information of the surrounding environment collected by a camera with the lane and object information of the vehicle extracted from the sensing information of the surrounding environment collected by a 3D LIDAR device, and provide integrated information, so that the surrounding environment information of the vehicle may be exactly detected, and thus the safe driving of a driver may be promoted.

Further, the present invention may prevent the vehicle from departing from a lane and from colliding with an obstacle, based on provided lane information and object information.

Although embodiments of the present invention have been described, the present invention may be modified in various forms, and those skilled in the art will appreciate that various modifications and changes may be implemented without departing from the spirit and scope of the accompanying claims.

What is claimed is:

1. An apparatus for providing surrounding environment information of a vehicle, comprising:
a first information extraction unit for collecting sensing information about a surrounding environment of a vehicle and extracting lane information and object information based on the sensing information;
a second information extraction unit for acquiring an image of the surrounding environment of the vehicle, and extracting lane information and object information based on the image; and
an information integration unit for matching and comparing the lane information and the object information extracted by the first information extraction unit with the lane information and the object information extracted by the second information extraction unit, determining ultimate lane information and ultimate object information based on results of comparison, and providing the ultimate lane information and the ultimate object information to a control unit of the vehicle.

2. The apparatus of claim 1, wherein the sensing information is obtained by emitting laser light and receiving reflected laser light, and is sensed by a three-dimensional (3D) Light Detection and Ranging (LIDAR) device in a form of information about a distance to an object, a direction of the object, and an angle with a road surface.

3. The apparatus of claim 1, wherein the first information extraction unit comprises:
a location information collection unit for collecting location information based on information about a distance between the vehicle and the object;
a reflectance information collection unit for collecting reflectance information based on information about an angle between the vehicle and a road surface;
a first conversion unit for combining the location information with the direction information, and converting combined information into 3D spatial coordinate information;
a first lane information extraction unit for extracting the lane information based on the reflectance information;
a first object information extraction unit for extracting the object information including any one of shape information and size information of the object based on the 3D spatial coordinate information; and
a first transmission unit for transmitting the extracted lane information and object information to the information integration unit.

4. The apparatus of claim 1, wherein the second information extraction unit comprises:
an image information acquisition unit for acquiring an image of the surrounding environment of the vehicle via an image acquisition unit;
a second lane information extraction unit for extracting the lane information including any one of shape, color, and location of a lane from the image; and
a second object information extraction unit for extracting the object information including any one of type, size, location, and velocity of the object from the image.

5. The apparatus of claim 1, wherein the second information extraction unit comprises:
a second conversion unit for converting the extracted lane information and object information into a form of 3D spatial coordinate information; and
a second transmission unit for transmitting the converted lane information and object information to the information integration unit.

6. The apparatus of claim 1, wherein the information integration unit comprises:
an information matching unit for performing time synchronization between the lane information and the object information extracted by the first information extraction unit and the lane information and the object information extracted by the second information extraction unit, and matching time-synchronized lane information and object information with predefined spatial coordinates;
a lane information comparison unit for comparing pieces of matched lane information with each other;
a lane information determination unit for measuring reliability values of the pieces of lane information based on results of comparison, and determining lane information having a highest reliability value to be ultimate lane information;
an object information comparison unit for comparing pieces of matched object information with each other;
an object information determination unit for measuring reliability values of the pieces of object information based on results of the comparison, and determining corresponding object information to be ultimate object information if a measured reliability value of the corresponding object information is equal to or greater than a preset reference reliability value; and
an information provision unit for providing the ultimate lane information and the ultimate object information to a control unit of the vehicle.

7. A method for providing surrounding environment information of a vehicle, comprising:
collecting, by a first information extraction unit, sensing information about a surrounding environment of a vehicle and extracting lane information and object information based on the sensing information, and acquiring, by a second information extraction unit, an image of the surrounding environment of the vehicle and extracting lane information and object information based on the image;
matching and comparing, by an information integration unit, the lane information and the object information extracted by the first information extraction unit with the lane information and the object information extracted by the second information extraction unit;
determining, by the information integration unit, ultimate lane information and ultimate object information based on results of comparison; and
providing, by the information integration unit, the ultimate lane information and the ultimate object information to a control unit of the vehicle.

8. The method of claim 7, wherein the sensing information is obtained by emitting laser light and receiving reflected laser light, and is sensed by a three-dimensional (3D) Light Detection and Ranging (LIDAR) device in a form of information about a distance to an object, a direction of the object, and an angle with a road surface.

9. The method of claim 7, wherein collecting the sensing information and extracting the lane information and the object information comprises:
collecting location information based on information about a distance between the vehicle and the object, and collecting reflectance information based on information about an angle between the vehicle and a road surface;
combining the location information with the direction information, and converting combined information into 3D spatial coordinate information;
extracting the lane information based on the reflectance information, and extracting the object information including any one of shape information and size information of the object based on the 3D spatial coordinate information; and
transmitting the extracted lane information and object information to the information integration unit.

10. The method of claim 7, wherein acquiring the image and extracting the lane information and the object information comprises:
acquiring an image of the surrounding environment of the vehicle via an image acquisition unit;
extracting the lane information including any one of shape, color, and location of a lane from the image, and extracting the object information including any one of type, size, location, and velocity of the object from the image;
converting the extracted lane information and object information into a form of 3D spatial coordinate information; and
transmitting the converted lane information and object information to the information integration unit.

11. The method of claim 7, wherein matching and comparing the lane information and the object information are configured to perform time synchronization between the lane information and the object information extracted by the first information extraction unit and the lane information and the object information extracted by the second information extraction unit, and to match and compare time-synchronized lane information and object information with predefined spatial coordinates.

12. The method of claim 7, wherein determining the ultimate lane information and the ultimate object information is configured to measure reliability values of pieces of lane information based on results of comparison, determine lane information having a highest reliability value to be ultimate lane information, measure reliability values of pieces of object information based on results of comparison, and determine corresponding object information to be ultimate object information if a measured reliability value of the corresponding object information is equal to or greater than a preset reference reliability value.
